(19) United States
(12) Patent Application Publication
(10) Pub. No.: US 2026/0205750 A1
(43) Pub. Date: Jul. 16, 2026

(54) ACOUSTIC SYSTEM

(71) Applicant: ALPS ALPINE CO., LTD., Tokyo (JP)

(72) Inventors: Hiroki HOSHIYAMA, Fukushima (JP); Tomoki TAKAHATA, Fukushima (JP)

(21) Appl. No.: 19/410,568

(22) Filed: Dec. 5, 2025

(30) Foreign Application Priority Data
Jan. 10, 2025 (JP) 2025-004011

(51) Int. Cl. H04R 29/00; H04R 3/00; H04R 9/02; H04R 9/04; H04R 9/06

(52) U.S. Cl. CPC H04R 29/003; H04R 3/00; H04R 9/025; H04R 9/046; H04R 9/06

(57) ABSTRACT

An acoustic system includes a speaker; a driver configured to drive the speaker by a drive signal generated from an audio signal to be input; and a displacement estimator. The speaker includes a first magnetic gap, a second magnetic gap overlapping the first magnetic gap as viewed in an axial direction of the speaker, and a first voice coil and a second voice coil that are fixed to a vibration system of the speaker configured to vibrate in the axial direction, such that the first voice coil and the second voice coil are positioned in the first magnetic gap and the second magnetic gap as viewed in the axial direction.

### CROSS-REFERENCE TO RELATED APPLICATIONS

The present application is based on and claims priority to Japanese Patent Application No. 2025-004011 filed on January 10, 2025, the entire contents of which are hereby incorporated by reference.

### BACKGROUND

### Field of the Invention

The present disclosure relates to a technique of increasing a stroke width of a speaker effectively controllable in driving.

### Description of the Related Art

A known technique related to the present disclosure obtains a constant driving force regardless of displacement of a vibration system of a speaker. This technique provides: two magnetic gaps, i.e., an upper magnetic gap and a lower magnetic gap in which directions of magnetic flux are opposite; and an upper voice coil having a winding width L, and a lower voice coil having the winding width L that is wound in a direction opposite to that of the upper voice coil. The upper voice coil and the lower voice coil are provided such that the total of the winding width of a lower portion of the upper voice coil in the upper magnetic gap and the winding width of an upper portion of the lower voice coil in the lower magnetic gap is L. See, for example, Japanese Laid-Open Patent Application Publication No. 1997-163495.

### SUMMARY

An acoustic system according to an embodiment of the present disclosure includes: a speaker; a driver including circuitry configured to drive the speaker by a drive signal generated from an audio signal to be input; and a displacement estimator. The speaker includes a first magnetic gap, a second magnetic gap overlapping the first magnetic gap as viewed in an axial direction of the speaker, and a first voice coil and a second voice coil that are fixed to a vibration system of the speaker configured to vibrate in the axial direction, such that the first voice coil and the second voice coil are positioned in the first magnetic gap and the second magnetic gap as viewed in the axial direction. With one direction of the axial direction being upward and another direction of the axial direction being downward, the first magnetic gap is provided upward of the second magnetic gap with a gap in the axial direction. The first voice coil is provided upward of the second voice coil with a gap in the axial direction. The first magnetic gap propagates magnetic flux in one direction of a radial direction of the speaker, and the second magnetic gap propagates the magnetic flux in another direction of the radial direction. The gap in the axial direction between the first magnetic gap and the second magnetic gap is greater than a winding width of each of the first voice coil and the second voice coil. The vibration system is provided to be capable of vibrating between a position at which at least a part of the first voice coil and at least a part of the second voice coil are located in the first magnetic gap, and a position at which at least the part of the first voice coil and at least the part of the second voice coil are located in the second magnetic gap. The displacement estimator includes circuitry configured to estimate positions of the first voice coil and the second voice coil in the axial direction of the speaker from a magnitude of the audio signal to be input. The circuitry included in the driver is configured to drive the first voice coil by a drive signal having a polarity that allows a direction of a current flowing through the first voice coil in accordance with a positive audio signal to be a first direction in a case in which a position estimated by the circuitry included in the displacement estimator is a position at which a portion of the first voice coil equal to or greater than a predetermined amount is located in the first magnetic gap. The driver is configured to drive the first voice coil by a drive signal having a polarity that allows the direction of the current flowing through the first voice coil in accordance with the positive audio signal to be a second direction opposite to the first direction in a case in which the position estimated by the circuitry included in the displacement estimator is a position at which the portion of the first voice coil equal to or greater than the predetermined amount is located in the second magnetic gap. The driver is configured to drive the second voice coil by a drive signal having a polarity that allows a direction of a current flowing through the second voice coil in accordance with the positive audio signal to be the first direction in a case in which the position estimated by the circuitry included in the displacement estimator is a position at which a portion of the second voice coil equal to or greater than a predetermined amount is located in the first magnetic gap. The driver is configured to drive the second voice coil by a drive signal having a polarity that allows the direction of the current flowing through the second voice coil in accordance with the positive audio signal to be the second direction in a case in which the position estimated by the circuitry included in the displacement estimator is a position at which the portion of the second voice coil equal to or greater than the predetermined amount is located in the second magnetic gap.

Here, in the above acoustic system, both the portion of the first voice coil equal to or greater than the predetermined amount and the portion of the second voice coil equal to or greater than the predetermined amount may be located in the first magnetic gap in a first range of displacement of the vibration system, and both the portion of the first voice coil equal to or greater than the predetermined amount and the portion of the second voice coil equal to or greater than the predetermined amount may be located in the second magnetic gap in a second range of displacement of the vibration system. In this case, the circuitry included in the driver may be configured to drive both the first voice coil and the second voice coil by the drive signal having the polarity that allows the direction of the current flowing in accordance with the positive audio signal to be the first direction in a case in which the position estimated by the circuitry included in the displacement estimator is a position at which both the portion of the first voice coil equal to or greater than the predetermined amount and the portion of the second voice coil equal to or greater than the predetermined amount are located in the first magnetic gap. The circuitry included in the driver may be configured to drive both the first voice coil and the second voice coil by the drive signal having the polarity that allows the direction of the current flowing in accordance with the positive audio signal to be the second direction in a case in which the position estimated by the circuitry included in the displacement estimator is a position at which both the portion of the first voice coil equal to or greater than the predetermined amount and the portion of the second voice coil equal to or greater than the predetermined amount are located in the second magnetic gap.

Also, in this acoustic system, the circuitry included in the driver may be configured to stop driving of the first voice coil in a case in which the position estimated by the circuitry included in the displacement estimator is a position at which the portion of the first voice coil equal to or greater than the predetermined amount is not located in the first magnetic gap and the second magnetic gap. Also, the circuitry included in the driver may be configured to stop driving of the second voice coil in a case in which the position estimated by the circuitry included in the displacement estimator is a position at which the portion of the second voice coil equal to or greater than the predetermined amount is not located in the first magnetic gap and the second magnetic gap.

Also, in this acoustic system, the displacement estimator may be set to include a correspondence between a range of the magnitude of the audio signal, and a combination of one first element in a first set and one second element in a second set. The first set is a set of displacement regions of the first voice coil, and includes first elements: a displacement region in which the portion of the first voice coil equal to or greater than the predetermined amount is located in the first magnetic gap; a displacement region in which the portion of the first voice coil equal to or greater than the predetermined amount is located in the second magnetic gap; and a displacement region in which the portion of the first voice coil equal to or greater than the predetermined amount is not located in the first magnetic gap and the second magnetic gap. The second set is a set of displacement regions of the second voice coil, and includes second elements: a displacement region in which the portion of the second voice coil equal to or greater than the predetermined amount is located in the first magnetic gap; a displacement region in which the portion of the second voice coil equal to or greater than the predetermined amount is located in the second magnetic gap; and a displacement region in which the portion of the second voice coil equal to or greater than the predetermined amount is not located in the first magnetic gap and the second magnetic gap. The circuitry included in the displacement estimator may estimate that the displacement region of the first voice coil and the displacement region of the second voice coil indicated by the combination corresponding to a range including the magnitude of the audio signal to be input are the positions of the first voice coil and the second voice coil in the axial direction of the speaker.

Also, in the above acoustic systems, the portion of the first voice coil equal to or greater than the predetermined amount may be a portion equal to or greater than n% of the first voice coil, where n is greater than 0, and the portion of the second voice coil equal to or greater than the predetermined amount may be a portion equal to or greater than n% of the second voice coil, where n is greater than 0.

Also, in the above acoustic systems, in a case in which an upper half of the first voice coil is located in a lower portion of the first magnetic gap, a lower half of the second voice coil may be located in an upper portion of the second magnetic gap.

Also, in the above acoustic systems, the gap, in the axial direction, between the first voice coil and the second voice coil may be 0.5L, and a length, in the axial direction, of the first magnetic gap and the second magnetic gap may be 1.5L, where L is the winding width of each of the first voice coil and the second voice coil.

### BRIEF DESCRIPTION OF THE DRAWINGS

FIG. 1 is a diagram illustrating a configuration of an acoustic system according to an embodiment of the present disclosure.

FIG. 2 is a diagram illustrating a configuration of a speaker according to the embodiment of the present disclosure.

FIG. 3A, FIG. 3B, FIG. 3C, FIG. 3D1, FIG. 3D2, FIG. 3D3, and FIG. 3D4 are diagrams illustrating a positional relationship between magnetic gaps and voice coils, according to the embodiment of the present disclosure.

FIG. 4 is a diagram illustrating a relationship between displacement and drive control of voice coils, according to the embodiment of the present disclosure.

FIG. 5 is a diagram illustrating an example of areas of an input audio signal, according to the embodiment of the present disclosure.

FIG. 6 is a diagram illustrating an example of the drive control of the voice coils, according to the embodiment of the present disclosure.

FIG. 7 is a diagram illustrating an example of the drive control of the voice coils, according to the embodiment of the present disclosure.

### DETAILED DESCRIPTION

By ensuring a large stroke width, a speaker having a small-diameter opening can reproduce a bass sound like in a speaker having large-diameter opening.

When increasing the stroke width, it is necessary to increase a winding width to avoid being uncontrollable due to displacement of a voice coil to a position deviating from a magnetic gap. However, when the winding width is increased, a driving force applied to the voice coil becomes smaller than that applied to a voice coil in which the winding width is substantially the same as the width of a magnetic gap. By increasing a gain of an input of the voice coil, it is possible to increase the driving force applied to the voice coil. In this case, however, power consumption increases. Also, when increasing the winding width, the weight of a vibration system including the voice coil increases, which is disadvantageous in terms of an output sound pressure.

It is an object of the present disclosure to increase the stroke width of a speaker effectively controllable in driving while reducing the winding width of voice coils.

Hereinafter, embodiments of the present disclosure will be described.

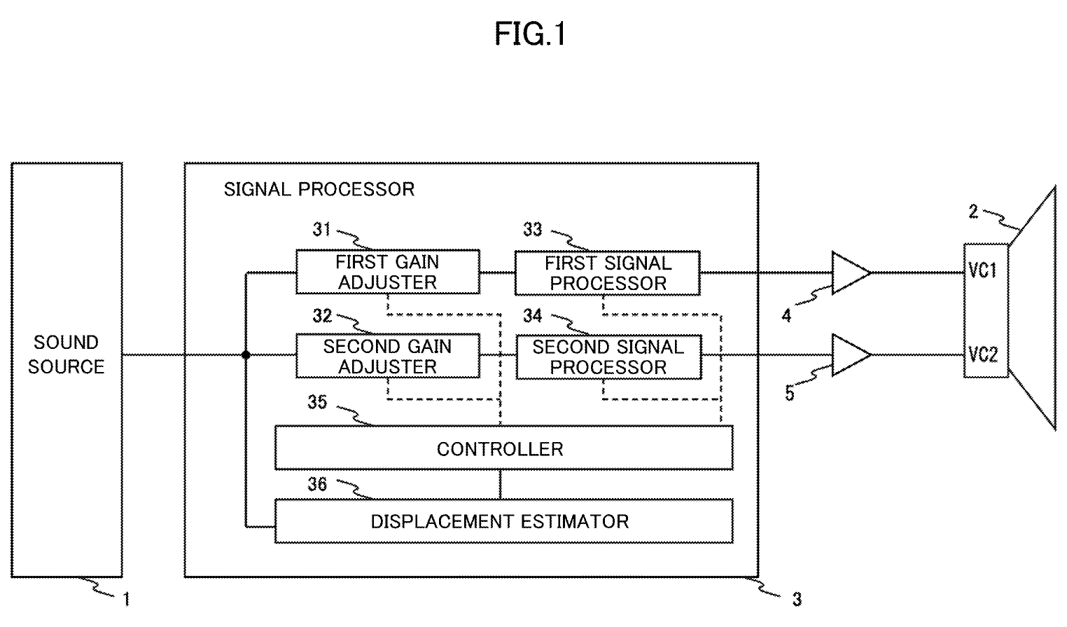

FIG. 1 is a diagram illustrating a configuration of an acoustic system according to an embodiment of the present disclosure.

As illustrated in FIG. 1, the acoustic system includes a sound source 1 configured to output an audio signal, a speaker 2, a signal processor 3, a first amplifier 4, and a second amplifier 5.

The signal processor 3 can be configured, for example, using a digital signal processor (DSP). The signal processor 3 includes a first gain adjuster 31, a second gain adjuster 32, a first signal processor 33, a second signal processor 34, a controller 35, and a displacement estimator 36.

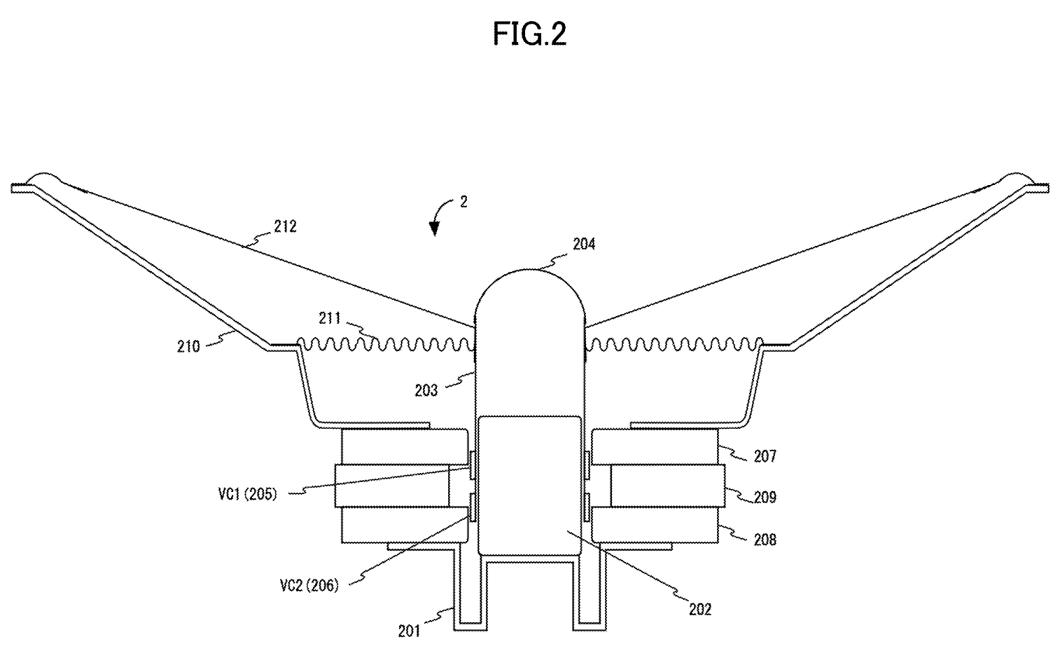

Next, a configuration of the speaker 2 is illustrated in FIG. 2.

As illustrated in FIG. 2, the speaker 2 includes a base 201, a yoke 202, a voice coil bobbin 203, a dust cap 204, a first voice coil VC1 (205), a second voice coil VC2 (206), a first plate 207, a second plate 208, a magnet 209, a frame 210, a damper 211, and a diaphragm 212.

When an upward direction in FIG. 2 in the axial direction of the speaker 2 is an upward direction of the speaker 2, and a downward direction in FIG. 2 in the axial direction of the speaker 2 is a downward direction of the speaker 2, the yoke 202 has a cylindrical shape and is supported at the center of the base 201. The voice coil bobbin 203 has a hollow cylindrical shape. The yoke 202 is inserted, from below, into the hollow of the voice coil bobbin 203 such that the voice coil bobbin 203 is movable upward and downward relative to the yoke 202. The first voice coil VC1 (205) is wound around the outer circumference of the voice coil bobbin 203, and the second voice coil VC2 (206) is wound around the outer circumference of the voice coil bobbin 203 at a position separated downward from the first voice coil VC1 (205).

Also, an annular second plate 208, supported at an outer circumferential portion of the base 201, an annular magnet 209, and an annular first plate 207 are provided, in sequence from below, at an outer circumferential portion of the yoke 202 and the voice coil bobbin 203.

Here, the yoke 202 and the second plate 208 are electrically and magnetically separated by the base 201. The yoke 202, the second plate 208, the magnet 209, and the first plate 207 form a magnetic circuit in which magnetism circulates through the magnet 209, the second plate 208, the yoke 202, the first plate 207, and the magnet 209.

The frame 210 is fixed to the base 201 through the yoke 202, the first plate 207, the magnet 209, and the second plate 208. An outer circumferential end of the diaphragm 212 is fixed to the frame 210, and an inner circumferential end of the diaphragm 212 is fixed to the voice coil bobbin 203.

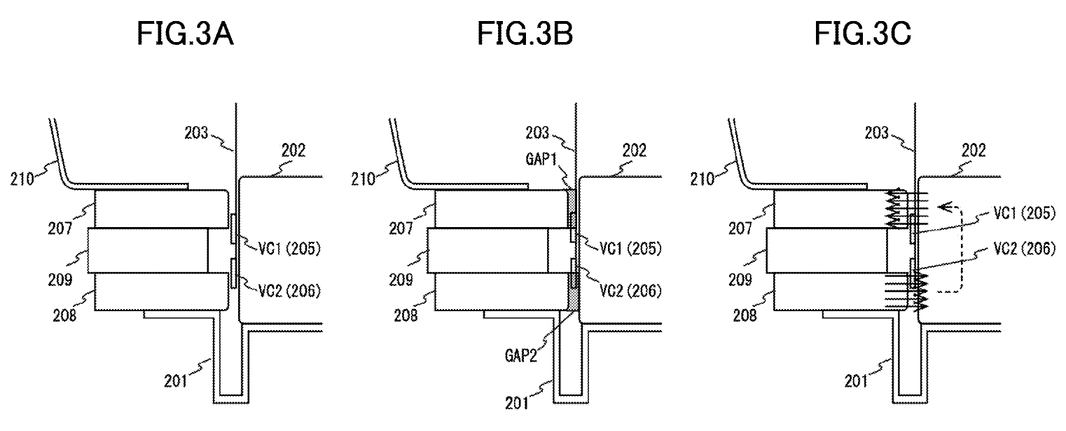

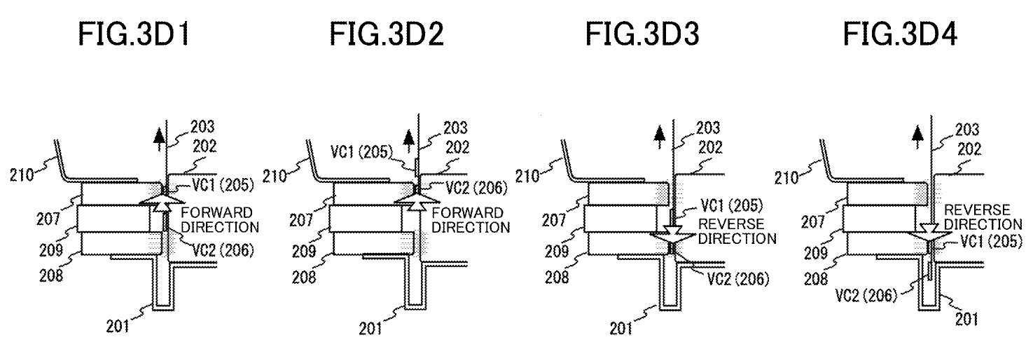

FIG. 3A illustrates a positional relationship between the yoke 202, the first voice coil VC1 (205), the second voice coil VC2 (206), the first plate 207, the second plate 208, and the magnet 209. As illustrated in FIG. 3B, a first magnetic gap GAP1 for passage of magnetic flux is formed between the first plate 207 and the yoke 202, and a second magnetic gap GAP2 for passage of magnetic flux is formed between the second plate 208 and the yoke 202. Also, as illustrated in FIG. 3C, a direction of the magnetic flux passing through the first magnetic gap GAP1 and a direction of the magnetic flux passing through the second magnetic gap GAP2 are opposite directions as viewed from a cross section including the axis of the speaker 2 in the plane. Here, the first magnetic gap GAP1 and the second magnetic gap GAP2 overlap with each other as viewed in the axial direction of the speaker 2.

The winding width (coil length/vertical height) of the first voice coil VC1 (205) is equal to the winding width of the second voice coil VC2 (206). Also, when the winding width of each of the first voice coil VC1 (205) and the second voice coil VC2 (206) is denoted by L, a gap between the first magnetic gap GAP1 and the second magnetic gap GAP2 is greater than L to prevent the first voice coil VC1 (205) or the second voice coil VC2 (206) from entering both the first magnetic gap GAP1 and the second magnetic gap GAP2. Also, the size and arrangement of each component are determined such that the top end of the second voice coil VC2 (206) enters the first magnetic gap GAP1 prior to passage of the bottom end of the first voice coil VC1 (205) through the top end of the first magnetic gap GAP1 when the voice coil bobbin 203 moves upward, and that the bottom end of the first voice coil VC1 (205) enters the second magnetic gap GAP2 prior to passage of the top end of the second voice coil VC2 (206) through the bottom end of the second magnetic gap GAP2 when the voice coil bobbin 203 moves downward.

Here, the present embodiment is described using an example in which the vertical width of the first magnetic gap GAP is 1.5L, the vertical width of the second magnetic gap GAP2 is 1.5L, the vertical width of the gap between the first magnetic gap GAP1 and the second magnetic gap GAP2 is 1.5L, and the vertical gap between the first voice coil VC1 (205) and the second voice coil VC2 (206) is 0.5L.

In the present embodiment, in a neutral state in which no signal is applied to the first voice coil VC1 (205) and the second voice coil VC2 (206), the first voice coil VC1 (205) and the second voice coil VC2 (206) are disposed such that the upper half of the first voice coil VC1 (205) is located in the first magnetic gap GAP1 and the lower half of the second voice coil VC2 (206) is located in the second magnetic gap GAP2.

In FIGS. 3D1 to 3D4, a direction in which a current flowing from the front toward the back (farther from a viewer) of the drawing sheet is defined as a forward direction, and a direction in which a current flowing from the back toward the front (closer to the viewer) of the drawing sheet is defined as a reverse direction. A direction of magnetic flux passing through the first magnetic gap GAP1 and a direction of magnetic flux passing through the second magnetic gap GAP2 are as illustrated in FIG. 3C. In this case, when at least a part of the first voice coil VC1 (205) is located in the first magnetic gap GAP1, as a current flows through the first voice coil VC1 (205) in the forward direction as illustrated in FIG. 3D1, an upward force is applied to the voice coil bobbin 203. Similarly, as illustrated in FIG. 3D2, when at least a part of the second voice coil VC2 (206) is located in the first magnetic gap GAP1, as a current flows through the second voice coil VC2 (206) in the forward direction, an upward force is applied to the voice coil bobbin 203. Whereas, as illustrated in FIG. 3D3, when at least a part of the second voice coil VC2 (206) is located in the second magnetic gap GAP2, as a current flows through the second voice coil VC2 (206) in the reverse direction, an upward force is applied to the voice coil bobbin 203. Similarly, as illustrated in FIG. 3D4, when at least a part of the first voice coil VC1 (205) is located in the second magnetic gap GAP2, as a current flows through the first voice coil VC1 (205) in the reverse direction, an upward force is applied to the voice coil bobbin 203.

The direction of magnetic flux generated by the first voice coil VC1 (205) or the second voice coil VC2 (206) when the current flows through the first voice coil VC1 (205) or the second voice coil VC2 (206) in the forward direction is opposite to the direction of magnetic flux generated by the first voice coil VC1 (205) or the second voice coil VC2 (206) when the current flows through the first voice coil VC1 (205) or the second voice coil VC2 (206) in the reverse direction. Also, when the current flows through the first voice coil VC1 (205) and the second voice coil VC2 (206) in the same direction, the directions of magnetic flux generated by the first voice coil VC1 (205) and the second voice coil VC2 (206) are the same.

Therefore, as long as at least a part of at least one of the first voice coil VC1 (205) or the second voice coil VC2 (206) is located in at least one of the first magnetic gap GAP1 or the second magnetic gap GAP2, application of an audio signal having an appropriate polarity to the first voice coil VC1 (205) or the second voice coil VC2 (206) exhibits an electromagnetic effect occurring between the magnetic flux generated in the first magnetic gap GAP1 or the second magnetic gap GAP2 and the signal flowing through the first voice coil VC1 (205) or the second voice coil VC2 (206). This electromagnetic effect applies vibration in accordance with the amplitude of a signal of a to-be-reproduced sound to the diaphragm 212 via the voice coil bobbin 203, thereby enabling generation of a sound in accordance with the signal of the to-be-reproduced sound.

As illustrated in FIG. 1, the displacement estimator 36 of the signal processor 3 estimates, from an audio signal output from the sound source 1, a region in which the first voice coil VC1 (205) or the second voice coil VC2 (206) is located, and outputs the estimated region to the controller 35.

Here, as this region, the following region is used: the first magnetic gap GAP1; the second magnetic gap GAP2; an intermediate region between the first magnetic gap GAP1 and the second magnetic gap GAP2; or an external region of GAP that is not the first magnetic gap GAP1, the second magnetic gap GAP2, or the intermediate region. That is, the external region of the GAP includes a region opposite to the second magnetic gap GAP2 across the first magnetic gap GAP1 and a region opposite to the first magnetic gap GAP1 across the second magnetic gap GAP2.

For the first voice coil VC1 (205), the displacement estimator 36 estimates whether the first voice coil VC1 (205) is located in the first magnetic gap GAP1, the second magnetic gap GAP2, the intermediate region, or the external region of the GAP, and outputs the estimated result to the controller 35. The first voice coil VC1 (205) being located in the first magnetic gap GAP1 refers to at least a part of the first voice coil VC1 (205) being located in the first magnetic gap GAP1. The first voice coil VC1 (205) being located in the second magnetic gap GAP2 refers to at least a part of the first voice coil VC1 (205) being located in the second magnetic gap GAP2. The first voice coil VC1 (205) being located in the intermediate region refers to the entirety of the first voice coil VC1 (205) being located in the intermediate region. The first voice coil VC1 (205) being located in the external region of the GAP refers to the entirety of the first voice coil VC1 (205) being located in the external region of the GAP.

Similarly, for the second voice coil VC2 (206), the displacement estimator 36 estimates whether the second voice coil VC2 (206) is located in the first magnetic gap GAP1, the second magnetic gap GAP2, the intermediate region, or the external region of the GAP, and outputs the estimated result to the controller 35. The second voice coil VC2 (206) being located in the first magnetic gap GAP1 refers to at least a part of the second voice coil VC2 (206) being located in the first magnetic gap GAP1. The second voice coil VC2 (206) being located in the second magnetic gap GAP2 refers to at least a part of the second voice coil VC2 (206) being located in the second magnetic gap GAP2. The second voice coil VC2 (206) being located in the intermediate region refers to the entirety of the second voice coil VC2 (206) being located in the intermediate region. The second voice coil VC2 (206) being located in the external region of the GAP refers to the entirety of the second voice coil VC2 (206) being located in the external region of the GAP.

Next, the first gain adjuster 31 performs gain adjustment of the audio signal input from the sound source 1 in accordance with a gain set by the controller 35, and outputs the adjusted audio signal to the first signal processor 33. The second gain adjuster 32 performs gain adjustment of the audio signal input from the sound source 1 in accordance with a gain set by the controller 35, and outputs the adjusted audio signal to the second signal processor 34.

The first signal processor 33 outputs, to the first amplifier 4, the audio signal input from the first gain adjuster 31. In addition, the first signal processor 33 performs processing for switching between the presence and absence of the output of the audio signal to the first amplifier 4 in accordance with the control by the controller 35, and processing for switching between the positive polarity and the negative polarity of the audio signal output to the first amplifier 4 in accordance with the control by the controller 35. Similarly, the second signal processor 34 outputs, to the second amplifier 5, the audio signal input from the second gain adjuster 32. In addition, the second signal processor 34 performs processing for switching between the presence and absence of the output of the audio signal to the second amplifier 5 in accordance with the control by the controller 35, and processing for switching between the positive polarity and the negative polarity of the audio signal output to the second amplifier 5 in accordance with the control of the controller 35.

The first amplifier 4 amplifies the audio signal, input from the first signal processor 33, at a predetermined gain, and outputs the amplified audio signal to the first voice coil VC1 (205) of the speaker 2. The second amplifier 5 amplifies the audio signal, input from the second signal processor 34, at the same gain as that in the first amplifier 4, and outputs the amplified audio signal to the second voice coil VC2 (206) of the speaker 2.

Hereinafter, control, performed by the controller 35, of the first signal processor 33 and the second signal processor 34 will be described.

The controller 35 controls the switching between the presence and absence of the output of the first signal processor 33 and the second signal processor 34, and the switching between the positive polarity and the negative polarity of the output audio signal in accordance with a region, estimated by the displacement estimator 36, in which the first voice coil VC1 (205) and the second voice coil VC2 (206) are located.

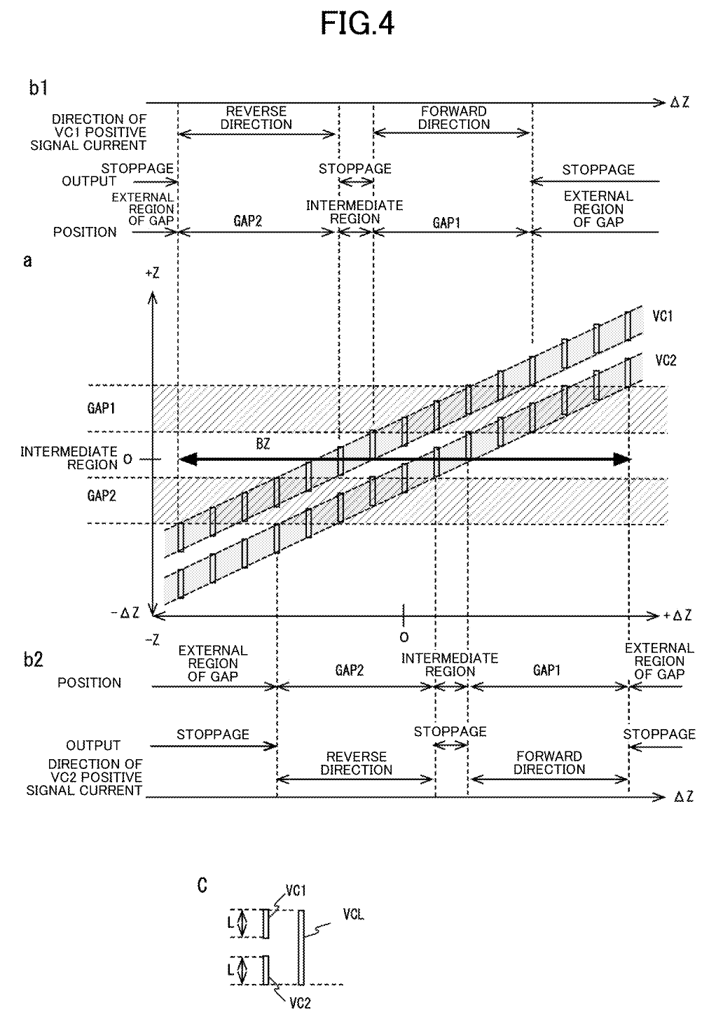

Here, section “a” of FIG. 4 illustrates a positional relationship between: a displacement ΔZ of the vibration system of the speaker 2; the first voice coil VC1 (205) and the second voice coil VC2 (206); and the first magnetic gap GAP1, the second magnetic gap GAP2, the intermediate region, and the external region of the GAP.

Also, section “b1” of FIG. 4 illustrates a relationship between the following controlled by the controller 35: the region in which the first voice coil VC1 (205) is located; the presence or absence of the output from the first signal processor 33 to the first amplifier 4; and the positive or negative polarity of the audio signal output to the first amplifier 4. Here, the positive or negative polarity of the audio signal output to the first amplifier 4 is indicated by a direction of the current flowing through the first voice coil VC1 (205) when a value of the audio signal input to the first signal processor 33 is positive. Also, section “b2” of FIG. 4 illustrates a relationship between the following controlled by the controller 35: the region in which the second voice coil VC2 (206) is located; the presence or absence of the output from the second signal processor 34 to the second amplifier 5; and the positive or negative polarity of the audio signal output to the second amplifier 5. Here, the positive or negative polarity of the audio signal output to the second amplifier 5 is indicated by a direction of the current flowing through the second voice coil VC2 (206) when a value of the audio signal input to the second signal processor 34 is positive.

The direction of the current flowing through the first voice coil VC1 (205) or the second voice coil VC2 (206) is indicated by the forward or reverse direction illustrated in FIGS. 3D1 to 3D4.

As illustrated, the controller 35 controls the positive or negative polarity of the audio signal output from the first signal processor 33 to the first amplifier 4 such that: when the first voice coil VC1 (205) is located in the first magnetic gap GAP1, as the value of the audio signal input to the first signal processor 33 is positive, a current flows through the first voice coil VC1 (205) in the forward direction; and when the first voice coil VC1 (205) is located in the second magnetic gap GAP2, as the value of the audio signal input to the first signal processor 33 is positive, a current flows through the first voice coil VC1 (205) in the reverse direction.

Also, the controller 35 controls the output from the first signal processor 33 to the first amplifier 4 to stop the output to the first amplifier 4 when the first voice coil VC1 (205) is located in the intermediate region or the external region of the GAP.

Also, the controller 35 controls the positive or negative polarity of the audio signal output from the second signal processor 34 to the second amplifier 5 such that: when the second voice coil VC2 (206) is located in the second magnetic gap GAP2, as the value of the audio signal input to the second signal processor 34 is positive, a current flows through the second voice coil VC2 (206) in the reverse direction; and when the second voice coil VC2 (206) is located in the first magnetic gap GAP1, as the value of the audio signal input to the second signal processor 34 is positive, a current flows through the second voice coil VC2 (206) in the forward direction.

Also, the controller 35 controls the output from the second signal processor 34 to the second amplifier 5 to stop the output to the second amplifier 5 when the second voice coil VC2 (206) is located in the intermediate region or the external region of the GAP.

As a result, when the speaker 2 is displaced in a range BZ, in section “a” of FIG. 4, that is a range between: a position at which the bottom end of the first voice coil VC1 (205) is the bottom end of the second magnetic gap GAP2; and a position at which the bottom end of the second voice coil VC2 (206) is the top end of the first magnetic gap GAP1, at least a part of at least one of the first voice coil VC1 (205) or the second voice coil VC2 (206) is located in at least one of the first magnetic gap GAP1 or the second magnetic gap GAP2. Thus, at least one of the first voice coil VC1 (205) or the second voice coil VC2 (206) can exhibit a driving force. In addition, in the range BZ, the control by the controller 35 as illustrated in sections “b1” and “b2” of FIG. 4 can apply a force to the voice coil bobbin 203 in a direction appropriate with respect to being positive or negative with respect to the audio signal output from the sound source 1, thereby vibrating the vibration system of the speaker 2.

Here, if the first magnetic gap GAP1 alone is provided as the magnetic gap, and the single voice coil is used to exhibit a driving force in the range BZ, it is necessary to provide a voice coil VCL, as illustrated in section “c” of FIG. 4, that has a winding width equal to a length from the top end of the first voice coil VC1 (205) to the bottom end of the second voice coil VC2 (206), i.e., a length exceeding the sum 2L of the winding width of the first voice coil VC1 (205) and the winding width of the second voice coil VC2 (206).

Therefore, according to the present embodiment, it is possible to increase the stroke width of the speaker 2 effectively controllable in driving without using a voice coil having a large winding width. Also, since the structure of the magnetic circuit is symmetrical in the vertical direction, asymmetrical distortion is unlikely to occur.

As illustrated in FIG. 1, the controller 35 controls the gain of the first gain adjuster 31 and the gain of the second gain adjuster 32 such that a response of the driving force caused by the first voice coil VC1 (205) and the second voice coil VC2 (206) can be obtained in accordance with an audio signal output from the sound source 1 in the above configuration.

Next, a description will be given of estimation, performed by the displacement estimator 36, of a region in which the first voice coil VC1 (205) and the second voice coil VC2 (206) are located, from an audio signal output from the sound source 1.

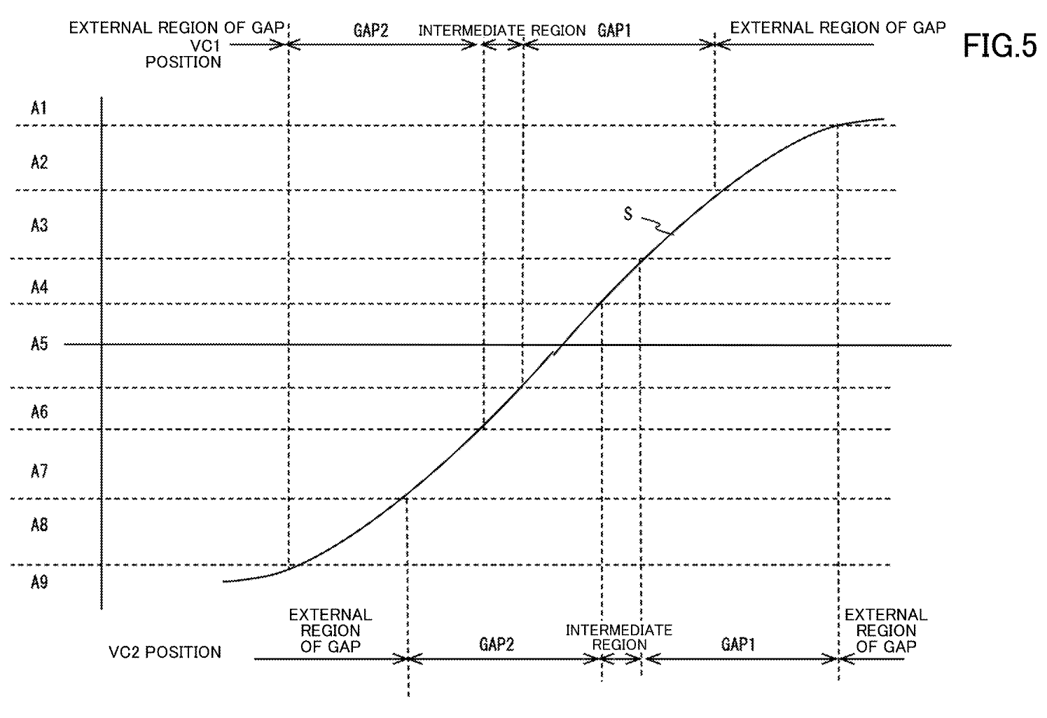

The displacement estimator 36 is previously set to include a correspondence, as illustrated in FIG. 5, between regions in which the first voice coil VC1 (205) and the second voice coil VC2 (206) are located, and nine areas A1 to A9 that are regions of the magnitude of the audio signal output from the sound source 1. Here, the respective areas are previously determined and set as the following areas.

Area A1: When the controller 35 performs the above control (i.e., the control of the gain of the first gain adjuster 31 and the gain of the second gain adjuster 32, and the control of switching between the presence and absence of the output of the first signal processor 33 and the second signal processor 34 and of switching the positive polarity and the negative polarity of the audio signal to be output) on an audio signal S at a level in the area A1, both the first voice coil VC1 (205) and the second voice coil VC2 (206) are located in the external region of the GAP, and the regions in which the first voice coil VC1 (205) and the second voice coil VC2 (206) are located are associated with each other.

Area A2: When the controller 35 performs the above control on the audio signal S at a level in the area A2, the first voice coil VC1 (205) is located in the external region of the GAP and the second voice coil VC2 (206) is located in the first magnetic gap GAP1, and the regions in which the first voice coil VC1 (205) and the second voice coil VC2 (206) are located are associated with each other.

Area A3: When the controller 35 performs the above control on the audio signal S at a level in the area A3, both the first voice coil VC1 (205) and the second voice coil VC2 (206) are located in the first magnetic gap GAP1, and the regions in which the first voice coil VC1 (205) and the second voice coil VC2 (206) are located are associated with each other.

Area A4: When the controller 35 performs the above control on the audio signal S at a level in the area A4, the first voice coil VC1 (205) is located in the first magnetic gap GAP1 and the second voice coil VC2 (206) is located in the intermediate region, and the regions in which the first voice coil VC1 (205) and the second voice coil VC2 (206) are located are associated with each other.

Area A5: When the controller 35 performs the above control on the audio signal S at a level in the area A5, the first voice coil VC1 (205) is located in the first magnetic gap GAP1 and the second voice coil VC2 (206) is located in the second magnetic gap GAP2, and the regions in which the first voice coil VC1 (205) and the second voice coil VC2 (206) are located are associated with each other.

Area A6: When the controller 35 performs the above control on the audio signal S at a level in the area A6, the first voice coil VC1 (205) is located in the intermediate region and the second voice coil VC2 (206) is located in the second magnetic gap GAP2, and the regions in which the first voice coil VC1 (205) and the second voice coil VC2 (206) are located are associated with each other.

Area A7: When the controller 35 performs the above control on the audio signal S at a level in the area A7, both the first voice coil VC1 (205) and the second voice coil VC2 (206) are located in the second magnetic gap GAP2, and the regions in which the first voice coil VC1 (205) and the second voice coil VC2 (206) are located are associated with each other.

Area A8: When the controller 35 performs the above control on the audio signal S at a level in the area A8, the first voice coil VC1 (205) is located in the second magnetic gap GAP2 and the second voice coil VC2 (206) is located in the external region of the GAP, and the regions in which the first voice coil VC1 (205) and the second voice coil VC2 (206) are located are associated with each other.

Area A9: When the controller 35 performs the above control on the audio signal S at a level in the area A9, both the first voice coil VC1 (205) and the second voice coil VC2 (206) are located in the external region of the GAP, and the regions in which the first voice coil VC1 (205) and the second voice coil VC2 (206) are located are associated with each other.

The displacement estimator 36 detects the area in which the magnitude of the audio signal output by the sound source 1 is included, estimates regions corresponding to the detected area as regions in which the first voice coil VC1 (205) and the second voice coil VC2 (206) are located, and outputs the estimated regions to the controller 35.

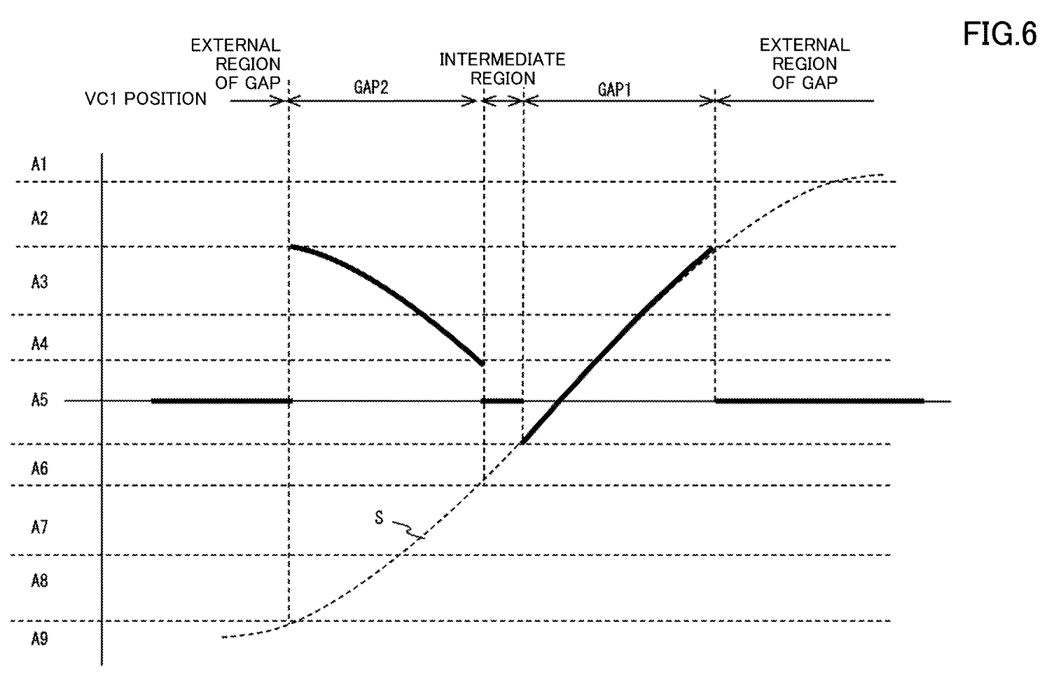

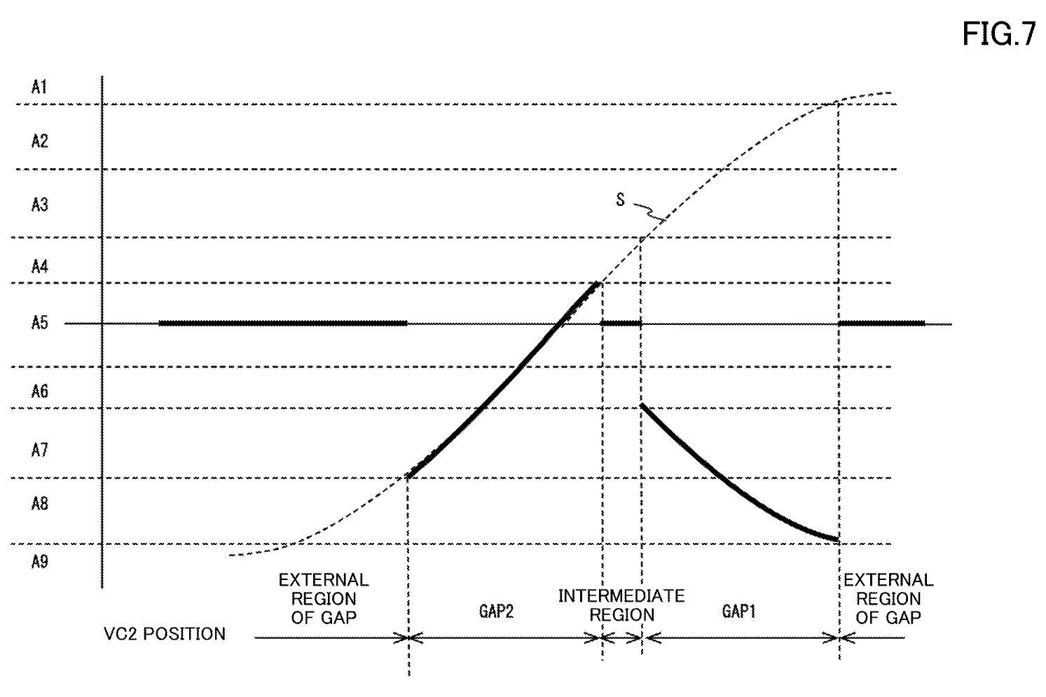

As a result of the control described above, when the value of an applied audio signal is positive, as the current flows through the first voice coil VC1 (205) in the forward direction and the current flows through the second voice coil VC2 (206) in the reverse direction, the output of the first signal processor 33 is controlled as illustrated in FIG. 6 and the output of the second signal processor 34 is controlled as illustrated in FIG. 7.

That is, as illustrated in FIG. 6, when the magnitude of the audio signal S output by the sound source 1 is located in the areas A1 and A2, the output of the first signal processor 33 is stopped. When the magnitude of the audio signal S output by the sound source 1 is located in the areas A3, A4, and A5, the polarity of the audio signal S is maintained. When the magnitude of the audio signal S output by the sound source 1 is located in the area A6, the output of the first signal processor 33 is stopped. When the magnitude of the audio signal S output by the sound source 1 is located in the areas A7 and A8, the polarity of the audio signal S is reversed. When the magnitude of the audio signal S output by the sound source 1 is located in the area A9, the output of the first signal processor 33 is stopped.

Also, as illustrated in FIG. 7, when the magnitude of the audio signal S output by the sound source 1 is located in the area A1, the output of the second signal processor 34 is stopped. When the magnitude of the audio signal S output by the sound source 1 is located in the areas A2 and A3, the polarity of the audio signal S is reversed. When the magnitude of the audio signal S output by the sound source 1 is located in the area A4, the output of the second signal processor 34 is stopped. When the magnitude of the audio signal S output by the sound source 1 is located in the areas A5, A6, and A7, the polarity of the audio signal S is maintained. When the magnitude of the audio signal S output by the sound source 1 is located in the areas A8 and A9, the output of the second signal processor 34 is stopped.

The correspondence, previously set in the displacement estimator 36, between the ranges of the nine areas A1 to A9 and the regions in which the first voice coil VC1 (205) and the second voice coil VC2 (206) are located is obtained, for example, in the following manner.

Specifically, the displacement estimator 36 is provided with a sensor configured to detect the displacement ΔZ of the vibration system of the speaker 2. In the displacement estimator 36, a region in which the first voice coil VC1 (205) and the second voice coil VC2 (206) are located is calculated from the displacement ΔZ detected by the sensor, and then output to the controller 35. In a state in which the above control is to be performed in the controller 35, a predetermined test signal (e.g., a sine wave) is output from the sound source 1 while gradually increasing the amplitude.

Then, in response to change in a combination of the regions, calculated by the displacement estimator 36, in which the first voice coil VC1 (205) and the second voice coil VC2 (206) are located, the magnitude of a test signal is stored in association with a boundary between an area corresponding to a combination of detected regions and an area corresponding to a combination of a region neighboring the above area in a direction in which the absolute value of the magnitude of the audio signal is smaller. As the magnitude of the test signal, the maximum value of the test signal is used when the combination of the detected regions corresponds to the magnitude of a positive audio signal, and the minimum value of the test signal is used when the combination of the detected regions corresponds to the magnitude of a negative audio signal.

Then, from the boundaries between the areas obtained in the above-described manner, the correspondence between the ranges of the nine areas A1 to A9 and the regions in which the first voice coil VC1 (205) and the second voice coil VC2 (206) are located is determined.

The embodiments of the present disclosure have been described above. Here, in the above embodiments, the displacement estimator 36 may estimate the displacement ΔX of the first voice coil VC1 (205) and the second voice coil VC2 (206) from the magnitude of the audio signal output by the sound source 1, and the controller 35 may control the gain of the first gain adjuster 31 and the gain of the second gain adjuster 32 in accordance with the displacement ΔX estimated by the displacement estimator 36 such that a response of the vibration system to the audio signal is equal in the range BZ illustrated in section “a” of FIG. 4.

According to the acoustic system as described above, at least one of the two voice coils having different ranges in the axial direction can selectively work on the first magnetic gap and the second magnetic gap that have different ranges in the axial direction and in which the directions of magnetic flux are opposite. Thus, it is possible to maintain the driving force in a wide displacement range of the vibration system while reducing the winding width of the voice coils, and as a result increase the stroke width of the speaker effectively controllable in driving.

As described above, according to the present disclosure, it is possible to increase the stroke width of the speaker effectively controllable in driving while reducing the winding width of the voice coils.

Note that the displacement estimator 36 is an example of the displacement estimator included in the acoustic system of the present disclosure. Each of the displacement estimator and the driver included in the acoustic system of the present disclosure is an electronic circuit (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit for specific applications.

What is claimed is:

1. An acoustic system, comprising:
a speaker;
a driver including circuitry configured to drive the speaker by a drive signal generated from an audio signal to be input; and
a displacement estimator, wherein
the speaker includes
a first magnetic gap,
a second magnetic gap overlapping the first magnetic gap as viewed in an axial direction of the speaker, and
a first voice coil and a second voice coil that are fixed to a vibration system of the speaker configured to vibrate in the axial direction, such that the first voice coil and the second voice coil are positioned in the first magnetic gap and the second magnetic gap as viewed in the axial direction,
with one direction of the axial direction being upward and another direction of the axial direction being downward, the first magnetic gap is provided upward of the second magnetic gap with a gap in the axial direction,
the first voice coil is provided upward of the second voice coil with a gap in the axial direction,
the first magnetic gap propagates magnetic flux in one direction of a radial direction of the speaker, and the second magnetic gap propagates the magnetic flux in another direction of the radial direction,
the gap in the axial direction between the first magnetic gap and the second magnetic gap is greater than a winding width of each of the first voice coil and the second voice coil,
the vibration system is provided to be capable of vibrating between
a position at which at least a part of the first voice coil and at least a part of the second voice coil are located in the first magnetic gap, and
a position at which at least the part of the first voice coil and at least the part of the second voice coil are located in the second magnetic gap,
the displacement estimator includes circuitry configured to estimate positions of the first voice coil and the second voice coil in the axial direction of the speaker from a magnitude of the audio signal to be input, and
the circuitry included in the driver is configured to:
drive the first voice coil by a drive signal having a polarity that allows a direction of a current flowing through the first voice coil in accordance with a positive audio signal to be a first direction in a case in which a position estimated by the circuitry included in the displacement estimator is a position at which a portion of the first voice coil equal to or greater than a predetermined amount is located in the first magnetic gap;
drive the first voice coil by a drive signal having a polarity that allows the direction of the current flowing through the first voice coil in accordance with the positive audio signal to be a second direction opposite to the first direction in a case in which the position estimated by the circuitry included in the displacement estimator is a position at which the portion of the first voice coil equal to or greater than the predetermined amount is located in the second magnetic gap;
drive the second voice coil by a drive signal having a polarity that allows a direction of a current flowing through the second voice coil in accordance with the positive audio signal to be the first direction in a case in which the position estimated by the circuitry included in the displacement estimator is a position at which a portion of the second voice coil equal to or greater than a predetermined amount is located in the first magnetic gap; and
drive the second voice coil by a drive signal having a polarity that allows the direction of the current flowing through the second voice coil in accordance with the positive audio signal to be the second direction in a case in which the position estimated by the circuitry included in the displacement estimator is a position at which the portion of the second voice coil equal to or greater than the predetermined amount is located in the second magnetic gap.

2. The acoustic system according to claim 1, wherein
both the portion of the first voice coil equal to or greater than the predetermined amount and the portion of the second voice coil equal to or greater than the predetermined amount are located in the first magnetic gap in a first range of displacement of the vibration system, and both the portion of the first voice coil equal to or greater than the predetermined amount and the portion of the second voice coil equal to or greater than the predetermined amount are located in the second magnetic gap in a second range of displacement of the vibration system, and
the circuitry included in the driver is configured to:
drive both the first voice coil and the second voice coil by the drive signal having the polarity that allows the direction of the current flowing in accordance with the positive audio signal to be the first direction in a case in which the position estimated by the circuitry included in the displacement estimator is a position at which both the portion of the first voice coil equal to or greater than the predetermined amount and the portion of the second voice coil equal to or greater than the predetermined amount are located in the first magnetic gap; and
drive both the first voice coil and the second voice coil by the drive signal having the polarity that allows the direction of the current flowing in accordance with the positive audio signal to be the second direction in a case in which the position estimated by the circuitry included in the displacement estimator is a position at which both the portion of the first voice coil equal to or greater than the predetermined amount and the portion of the second voice coil equal to or greater than the predetermined amount are located in the second magnetic gap.

3. The acoustic system according to claim 2, wherein
the circuitry included in the driver is configured to:
stop driving of the first voice coil in a case in which the position estimated by the circuitry included in the displacement estimator is a position at which the portion of the first voice coil equal to or greater than the predetermined amount is not located in the first magnetic gap and the second magnetic gap; and
stop driving of the second voice coil in a case in which the position estimated by the circuitry included in the displacement estimator is a position at which the portion of the second voice coil equal to or greater than the predetermined amount is not located in the first magnetic gap and the second magnetic gap.

4. The acoustic system according to claim 3, wherein
the displacement estimator is set to include a correspondence between a range of the magnitude of the audio signal, and a combination of one first element in a first set and one second element in a second set,
the first set is a set of displacement regions of the first voice coil, and includes first elements:
a displacement region in which the portion of the first voice coil equal to or greater than the predetermined amount is located in the first magnetic gap;
a displacement region in which the portion of the first voice coil equal to or greater than the predetermined amount is located in the second magnetic gap; and
a displacement region in which the portion of the first voice coil equal to or greater than the predetermined amount is not located in the first magnetic gap and the second magnetic gap, and
the second set is a set of displacement regions of the second voice coil, and includes second elements:
a displacement region in which the portion of the second voice coil equal to or greater than the predetermined amount is located in the first magnetic gap;
a displacement region in which the portion of the second voice coil equal to or greater than the predetermined amount is located in the second magnetic gap; and
a displacement region in which the portion of the second voice coil equal to or greater than the predetermined amount is not located in the first magnetic gap and the second magnetic gap, and
the circuitry included in the displacement estimator estimates that the displacement region of the first voice coil and the displacement region of the second voice coil indicated by the combination corresponding to a range including the magnitude of the audio signal to be input are the positions of the first voice coil and the second voice coil in the axial direction of the speaker.

5. The acoustic system according to claim 1, wherein
the portion of the first voice coil equal to or greater than the predetermined amount is a portion equal to or greater than n% of the first voice coil, where n is greater than 0, and
the portion of the second voice coil equal to or greater than the predetermined amount is a portion equal to or greater than n% of the second voice coil, where n is greater than 0.

6. The acoustic system according to claim 1, wherein
in a case in which an upper half of the first voice coil is located in a lower portion of the first magnetic gap, a lower half of the second voice coil is located in an upper portion of the second magnetic gap.

7. The acoustic system according to claim 6, wherein
the gap, in the axial direction, between the first voice coil and the second voice coil is 0.5L, and a length, in the axial direction, of the first magnetic gap and the second magnetic gap is 1.5L, where L is the winding width of each of the first voice coil and the second voice coil.
